(19) United States
(12) Patent Application Publication
(10) Pub. No.: US 2006/0079265 A1
(43) Pub. Date: Apr. 13, 2006

(54) Wireless system

(75) Inventor: Yoshio Masuda, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/049,426

(22) Filed: Feb. 2, 2005

(30) Foreign Application Priority Data
Sep. 27, 2004 (JP) 2004-279158

(51) Int. Cl. H04B 1/04

(52) U.S. Cl. 455/522; 455/69

(57) ABSTRACT

The measured total power supply and the number of terminals (traffic volume) covered by a base station are obtained from the base station. From the traffic volume, the total power supply required to the base station is estimated. The measured total power supply is compared with the estimated total power supply, and a correction value to the maximum downlink power supply per channel is calculated when it is determined that the base station has remaining power for radio wave transmission. The correction value of the maximum downlink power supply per channel is set at the base station. Because the corrected value is larger than the pre-correction maximum downlink power supply per channel, the base station can transmit radio waves at a larger power making speech quality of its terminals improve when the base station has remaining power supply.

### BACKGROUND OF THE INVENTION

1. Field of the Invention

The present invention relates to a wireless system adopting a technique of controlling the downlink transmission power depending on data traffic conditions.

2. Description of the Related Art

In WCDMA systems, the total power for signal transmission that a base station can supply is limited. Therefore, it is desirable to maintain good speech quality and to cover as many subscribers as possible with a given power supply. In order to cover as many subscribers as possible per base station, maximum power per subscriber or channel needs be limited, to the minimum power required to maintain a given signal quality.

On the contrary, when subscribers make a call or move around locations subject to weaker radio wave signals such as behind a building or on the border of the service area, it is desired that the upper limit of power per channel is supplied with margin in order to satisfy the demand for speech quality.

Setting the upper limit of power supplied per channel and thus speech quality leads to a compromise between the number of subscribers who can be covered by a base station and speech quality.

That is, if maximum downlink power per channel allocated to subscribers is decreased, the number of subscribers who can receive the service would increase within a cell, however good speech quality cannot be maintained. Conversely, if the maximum downlink power per channel allocated to subscribers is increased to improve speech quality, the number of users to whom the service can be provided would decrease because good speech quality must be maintained.

There are some existing techniques such as the ones described in Patent Document 1 and Patent Document 2. Patent Document 1 discloses a technique that allows data acquisition of the power supply value and signal quality received by a moving station including the transmission power supply data in transmitted signal, when a base station transmits radio wave with a certain amount of power supply and allows selection of an optimum base station. In Patent Document 2, a technique is described for open-loop power supply control using a desired signal rate, transmission path-loss through wireless communication channel and an interference value.
Patent Document 1: Japanese patent application publication bulletin No. H11-8878
Patent Document 2: Japanese patent application publication No. 2002-539707

With these existing techniques, when service is provided at the estimated maximum traffic volume (the maximum number of users), the value of the maximum downlink power supply per channel allocated to users is set so as to provide a minimum quality that does not affect a phone call, and the value is fixed.

In this manner, speech quality during maximum traffic volume is maintained at a level that does not affect the phone call. However, because it is a fixed value setting, there are some cases where to secure sufficient quality for a phone call is difficult, when phone calls are made moving around locations subject to weaker radio wave signals such as the border of the service area even if the traffic volume is small and the base station has surplus power to increase the downlink power, because the maximum downlink power supply per channel allocated to users is fixed.

In such cases, users have to tolerate the some degree of speech quality degradation, even though the base station has remaining power to supply.

### SUMMARY OF THE INVENTION

It is an object of the present invention to provide a wireless control system, which allows users to make phone calls with improved speech quality when the base station has remaining power to supply.

A wireless system of the present invention is a wireless system, which performs wireless communication between base stations and terminals, comprising a station information collecting unit collecting data pertaining to the total power supply from the base station and traffic volume, the number of terminals covered by the base station, a total power supply estimation unit estimating the total power supply required for the base station from the traffic volume, a status determining unit determining whether the base station has remaining power to supply or not using the actual total power supply and the estimated total power supply and a correcting unit correcting the setting of the maximum downlink power supply per channel that is provided to radio wave transmitted to terminals to larger value when it is determined that the base station has some remaining power to supply by the status determining unit.

With the wireless system of the present invention, users are satisfied with the speech quality provided when they make phone calls in an area where it is considered to be a weak radio wave area such as behind buildings and on the border of service areas or when they make phone calls moving around the weak radio wave area. Also, operators can decrease the number of claims on the speech quality from users.

### BRIEF DESCRIPTION OF THE DRAWINGS

FIG. 1A and FIG. 1B are block diagrams of a wireless communication system required to operate control according to the embodiment of the present invention regarding only parameters of each base station;

FIG. 2 is a processing flowchart showing control of the maximum downlink power supply per channel at the base station on controlling in terms of parameter of each base station;

FIG. 3 is a diagram describing traffic distribution;

FIG. 4 is a processing flowchart of status assessment step S13;

FIG. 5 is a block diagram describing a wireless communication system controlled in view of interference from neighboring base stations in the embodiment of the present invention; and

FIG. 6 is a flowchart showing processing to control the maximum downlink power supply per channel at a base station in view of interference from neighboring base stations.

### DESCRIPTION OF THE PREFERRED EMBODIMENTS

The present invention allows control of a trade-off relationship of speech quality and base station downlink power supply (the maximum downlink power supply per channel allocated to users) in relation to traffic volume. When the traffic volume is less than the expected number of users, a base station has remaining power to supply. Then, total downlink power supply required for the base station is estimated based on the traffic volume of a cell, which the base station covers. When the actual total power supply is larger than the estimated total power supply, that is, when there is remaining downlink power supply, the setting is changed so that the maximum downlink power supply is increased. By so doing, users moving into an environment where speech quality is degraded (phone calls around locations subject to weak radio wave signals such as behind buildings and on the border of service areas), have to tolerate a degradation of speech quality under the existing system with the fixed maximum downlink power supply per channel. However, good speech quality is secured by increasing the downlink power supply per channel.

Additionally, when traffic volume within the cell in one base station is small but is large in neighboring base stations, by monitoring neighboring base stations, the system controls the maximum downlink power supply per channel allocated to users regarding interference to the neighboring base stations when the total downlink power supply per channel allocated to users is increased.

The present invention has a parameter for setting the maximum downlink power supply per channel allocated to users by the downlink power supply at the base station. Also, the present invention comprises a unit summing the number of users to whom the service is provided within a cell and a uint controlling the maximum downlink power supply per channel allocated to users based on the summed traffic volume within the cell.

Moreover, the present invention has a unit summing the traffic volume data of the neighboring base stations, when the base station has neighboring base stations. It also has a unit controlling the maximum downlink power supply per channel allocated to users regarding the interference to the neighboring base stations, based on the traffic volume of the neighboring base stations.

According to the present invention, better speech quality can be provided to users during a phone call moving around locations subject to weaker radio wave signals such as behind buildings and at the border of the service area when traffic volume is small.

With reference to the drawings, an explanation of a preferred embodiment of the present invention is provided below.

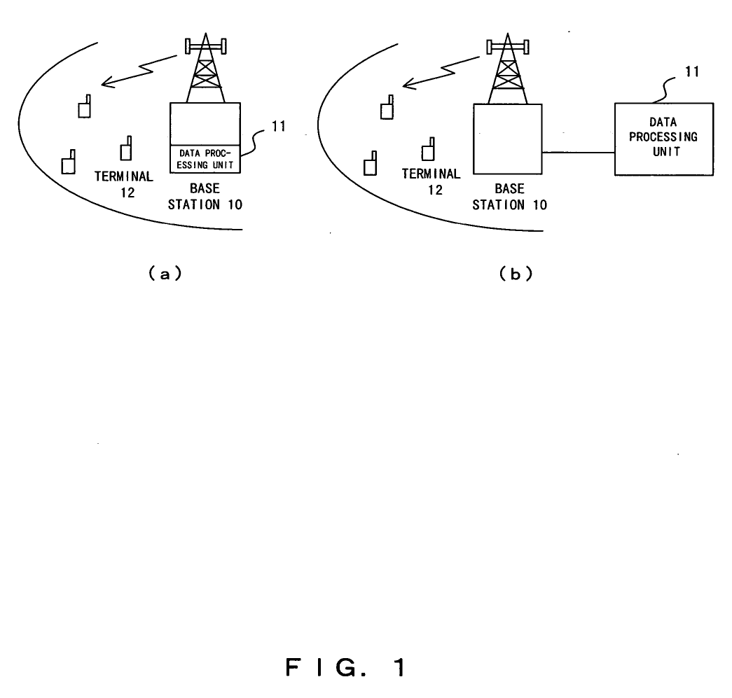

FIG. 1A and FIG. 1B are block diagrams of a wireless communication system required to operate control according to the embodiments of the present invention regarding only parameters of each base station.

In the embodiments of the present invention, a wireless communication system comprises a base station 10 and a data processing unit 11. The data processing unit 11 can be located either within the base station 10 (FIG. 1A) or outside the base station 10 (FIG. 1B). In FIG. 1A, the data processing unit 11, which performs control operations in the embodiment of the present invention, is embedded in a configuration of the base station 10, and obtains traffic volume and measured total power supply data from the other function of the base station 10. In FIG. 1B, the data processing unit 11 is built separately and is remote to the base station 10. The traffic volume and measured total power supply data is obtained through a network. In the case of FIG. 1B, the data processing unit 11 can be set up, for example, in a Radio Network Controller (RNC).

To a terminal 12, radio waves are transmitted from the base station 10 within the maximum downlink power supply per channel assigned by the data processing unit 11.

The configuration of the wireless system according to the embodiment of the present invention is not limited to the configurations described above, but the system can take various configurations.

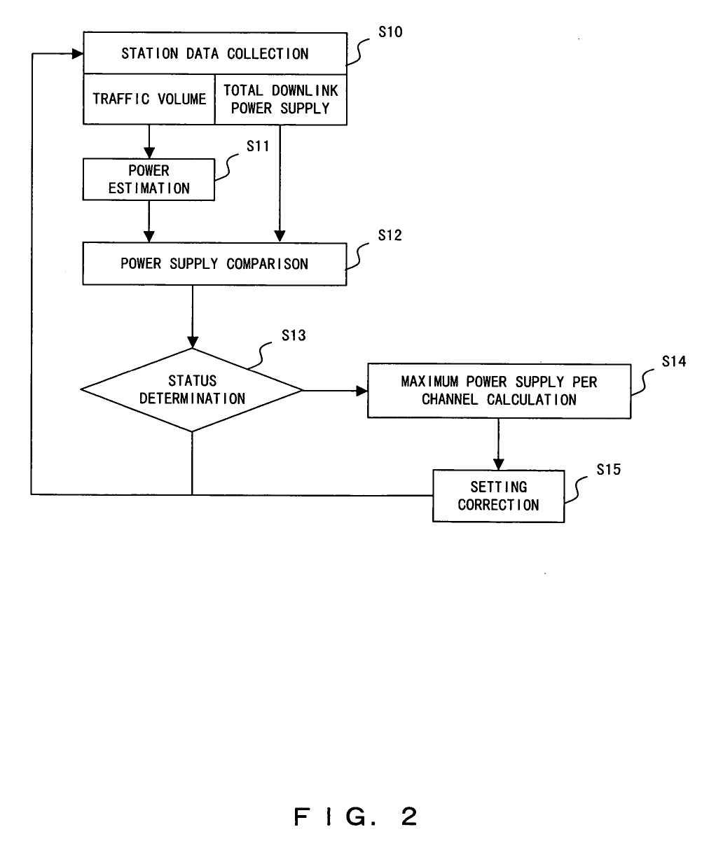

FIG. 2 is a processing flowchart showing control of the maximum downlink power supply per channel at the base station on controlling in terms of parameter of each base station.

The processing flow in FIG. 2 proceeds in data processing unit 11 described in FIG. 1. In data collection step S10, traffic volume and actual total power supply data at the base station in a certain time period is collected. The traffic volume is obtained from the number of physical channel and is the number of all terminals currently call-connecting.

And if possible, traffic volume for each service type is collected.

In power estimation step S11, it is assumed that terminals are uniformly distributed within the cell which the base station covers. On the basis of this assumption, the total power supply for base station radio wave transmission is estimated from the traffic volume obtained in data collection step S10.

In the power supply comparison step S12, the estimated total power supply of uniform terminal distribution estimated in power estimation step S11 is compared with the actual total power supply collected in data collection step S10. From the comparison, data required to determine the status for correction of the maximum downlink power supply per channel is calculated.

In the status assessment step S13, the distribution status of terminals belonging to the base station is determined based on the result from the comparison result of the power supply comparison step S12, and the status for correction of maximum downlink power supply per channel are determined.

In the maximum power supply per channel calculation step S14, the maximum downlink power supply after the correction is calculated based on the correction status in the status determination step S13.

In the setting correction step S15, the result of the maximum power supply per channel calculation step S14 is applied to the data of the base station.

The explanation of a computation method employed by the data processing unit which controls each base station in terms of parameter is provided below, assuming that the actual traffic volume is N [terminals] and total power supply is P [w] as station data collected in data collection step S10 in FIG. 2.

An equation expressing the performance of a base station device is given below.
(Eb/No)=W/R (Ptra*L)/{(Poh+N*Ptra*v)*(h+f)*L+No*NF*W}
where, total power supply is given as P=Poh+N*Ptra*v
(Eb/No): energy per user bit divided by noise spectrum density
W: chip rate [cps] (3.84 Mcps)
R: data rate [bps]
Ptra: power supply required for signal transmission per channel [Watt/bit]
L: propagation loss
Poh: total power supply required for transmission common channel(control channel power supply)
v: activity factor
h: orthgonality factor
f: interference factor
No: thermal noise [Watts/Hz]
NF: noise figure
No=kT
k=1.38×10−23 (Boltzmann constant)
T=273+C (Absolute temperature)
C: temperature (Celsius)
Power supply required per channel (Ptra) is calculated by solving the above equation for Ptra.
   Ptra=(Eb/No)/(W/R)*{Poh*(h+f)+Nt/T(r)}/{1-(Eb/No)/(W/R)*N*v*(h+f)} (1)

Now, the following values are given as examples. Eb/No=6.0 [dB], W=3.84 [MHz], R=12.2 [Kbps], Poh=4 [W], h=0.5, f=0, v=1, NONFW=−101 [dBm]

In power estimation step S11 in FIG. 2, the power supply required for the base station to transmit radio waves is estimated for comparison in the power supply comparison step S12, assuming that terminals with the traffic volume acquired in data collection step S10 are uniformly distributed within a service area.

In order to estimate the power supply on the assumption of a uniform distribution of the terminals, the distribution of traffic volume, traffic distribution, is calculated from the number of terminals distributed in each area by setting areas by area ratio

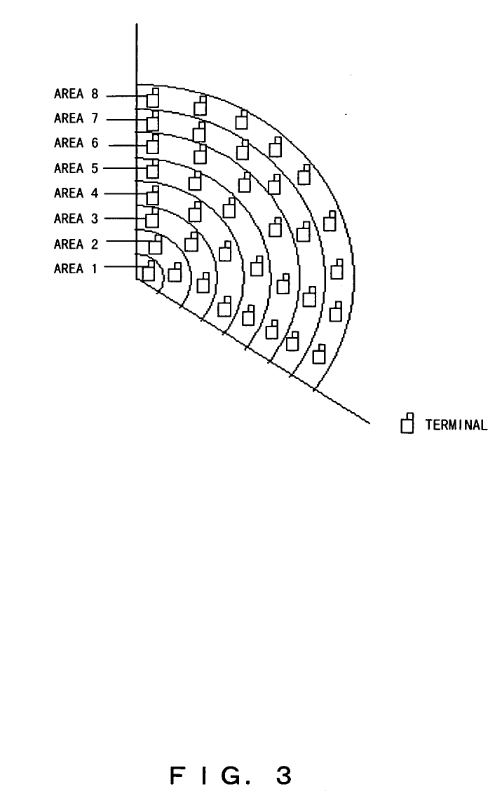

FIG. 3 is a diagram describing traffic distribution.

The number of terminals existing is the same within every unit area under the assumption that the terminals are uniformly distributed within an area. That is, the number of terminals in a specific area is proportional to the size of the area. Therefore, if the number of the terminals covered by a base station is given, by measuring the size of the area in a cell and calculating the area ratio, the covered terminals are allotted to each area based on the area ratio.

The cell is divided into areas shown in FIG. 3. The number of terminals, which is proportional to the area ratio (the radius squared), is given in Table 1.

TABLE 1
Ratio of traffic distribution in each area given a
uniform distribution of terminals

| | | | |
|---|---|---|---|
| | | Propagation | |
| Area | Radius | loss | Ratio |

| | | | | | |
|---|---|---|---|---|---|
| 1 | 200 | m | 114 dB | 1.6 | % |
| 2 | 400 | m | 125 dB | 4.7 | |
| 3 | 600 | m | 131 dB | 7.9 | |
| 4 | 800 | m | 135.5 dB | 11.0 | |
| 5 | 1 | km | 139 dB | 15.0 | |
| 6 | 1.2 | km | 141.6 dB | 16.1 | |
| 7 | 1.4 | km | 144 dB | 20.9 | |
| 8 | 1.6 | km | 146 dB | 22.8 | |

COST231-Hata model is used for calculation of propagation loss in each area.

Also the height of the antenna of the base station is required for the calculation (30 m in the present example).
COST231-Hata Model

$$\begin{matrix}L = 46.3 + 33.9 log F - 13.82 log hb - a ( hm ) + ( 44.9 - 6.55 log hb ) * log d \\ a ( hm ) = 3.2 * \{ log ( 11.75 * hm ) \} \hat{} 2 - 4.97 \\ L\_urban = L + CM\_urban \\ L\_sub \text{-} urban = L - 2 * \{ log ( f / 28 ) \} \hat{} 2 - 5.4\end{matrix}$$

L: propagation loss
F: frequency
hb: height of base station antenna
hm: height of the terminal
d: radius of the area

L_urban and L_sub-urban are equations to calculate the propagation loss in the urban area where large-scale radio disturbance occurs from the given propagation loss. CM_urban is given before the calculation. Table 2 shows the calculation of the traffic distribution when the traffic volume is 30 channels.

TABLE 2
Traffic distribution in each area with traffic volume
of 30 terminals

| | | | | |
|---|---|---|---|---|
| | | Propagation | | Traffic |
| Area | Radius | loss | Ratio | distribution |

| | | | | | | | |
|---|---|---|---|---|---|---|---|
| 1 | 200 | m | 114 dB | 1.6 | % | 1 | terminals |
| 2 | 400 | m | 125 dB | 4.7 | | 1 | |
| 3 | 600 | m | 131 dB | 7.9 | | 2 | |
| 4 | 800 | m | 135.5 dB | 11.0 | | 3 | |
| 5 | 1 | km | 139 dB | 15.0 | | 5 | |
| 6 | 1.2 | km | 141.6 dB | 16.1 | | 5 | |
| 7 | 1.4 | km | 144 dB | 20.9 | | 6 | |
| 8 | 1.6 | km | 146 dB | 22.8 | | 7 | |

The maximum downlink power supply per channel required in each area is calculated using equation (1).

Based on this result, the power supply required for each area is calculated from the product of the maximum downlink power supply per channel and the traffic volume of each area, and the sum of the required power supply in each area gives the total power supply required in each areas on the assumption of a uniform distribution of terminals.

TABLE 3
Power required for each area

| | | | | |
|---|---|---|---|---|
| | Power | Power | Traffic CH | |
| | required | supply | total | |
| | per | for each | power | |
| Area | channel | area | supply | Poh added |

| | | | | | | | | |
|---|---|---|---|---|---|---|---|---|
| 1 | 25.8 | mW | 0.03 | W | 6.7 | W | 10.7 | W |
| 2 | 28.9 | | 0.03 | | | | | |
| 3 | 38.9 | | 0.08 | | | | | |
| 4 | 63.0 | | 0.19 | | | | | |
| 5 | 110.6 | | 0.55 | | | | | |
| 6 | 179.2 | | 0.90 | | | | | |
| 7 | 296.2 | | 1.78 | | | | | |
| 8 | 456.6 | | 3.20 | | | | | |

From the calculation, the estimated total power supply under the status of uniform terminal distribution is 10.7W (including the control channel, or Poh, established besides traffic channels) in the present example. Here, 4 [w] is assigned to Poh.

In power supply comparison step S12 of FIG. 2, the above-estimated total power supply calculated in power estimation step S11 is compared with the measured total power supply collected in data collection step S10. The result is sent to the status assessment step S13.

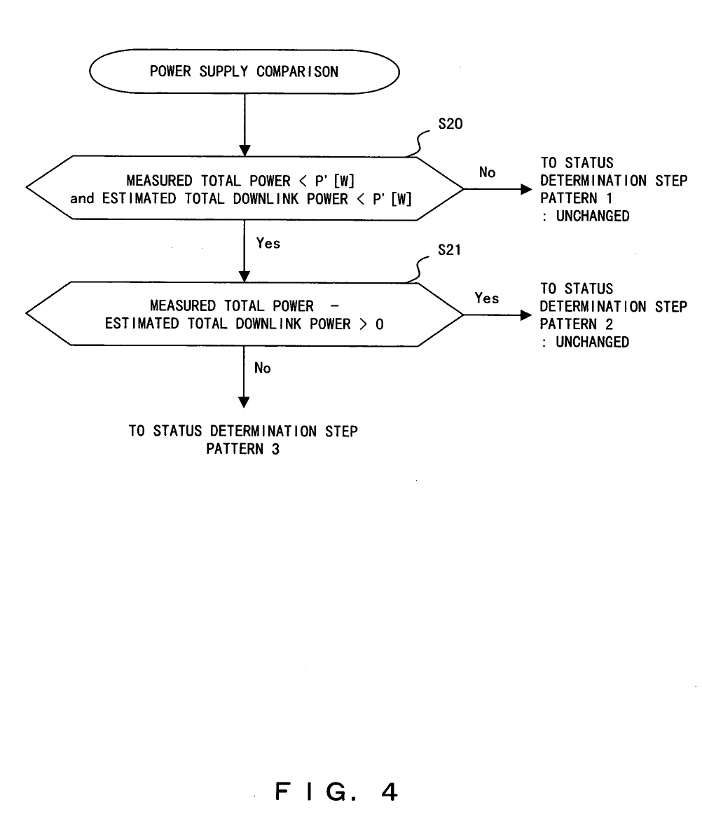

FIG. 4 is a processing flowchart of status assessment step S13.

In FIG. 4, P′ is the upper limit of the total power supply of the base station, and the limit can be manually set by operators. A value to be set as the upper limit can be the maximum downlink power supply or a value from which the energy concerning the influence of fading by movement of terminal is subtracted.

In step S20, it is assessed whether both the measured total power supply and the estimated transmission power supply are less than P′ or not. If the assessment at step S20 is no, it is classified as pattern 1 and the status is further assessed, however, the power supply setting is not altered. If the assessment at step S20 is yes, the processing proceeds to step S21. In step S21, whether the value of the measured total power supply minus the estimated total power supply exceeds zero or not is assessed. If the assessment at step S21 is yes, it is classified as pattern 2 and the status is further assessed, however, power supply setting remains unchanged. If the determination at step S21 is no, it is classified as pattern 3 and the status is further assessed.

In status assessment step S13 depicted in FIG. 2, the following approach allows the assessment of the need for correction of the maximum downlink power supply per channel and the determination of altered power supply.

Pattern 1: measured total power supply=P′ [W], or estimated total power supply≧P′.

The electric power supply has reached the limit of the maximum downlink power supply that the base station can use, thus the maximum downlink power supply per channel is not altered. That is, the base station cannot afford further power supply to improve speech quality at terminals.

Pattern 2: measured total power supply—estimated total power supply>0.

Terminals are considered to be gathering around the boundary (edge of coverage) of the area covered by the base station. In this situation, it is not desirable to alter (to increase) the maximum downlink power supply, thus the maximum downlink power supply per channel is not altered. To be more specific, when it is assumed that terminals are gathering around the edge of the service area, if the locations of terminals move toward edge of the area that is covered or go into shade, an increase in power supply might be requested by the terminals to the base station. If the upper limit of the power supply per channel (maximum downlink power supply) were set high at this point, troubles such that the actual total power supply might exceed the upper limit that the base station set would possibly occur. Therefore, regarding the condition of each terminal, the existing setting is kept unchanged so that the actual total power supply can be controlled with remaining power.

Pattern 3: measured total power supply−estimated total power supply≧0

Compared with the traffic volume, the power supply at the base station has surplus power to supply in this status. Therefore, the maximum downlink power supply per channel can be corrected. The result is sent to the maximum power supply per channel calculation step S14.

In the maximum power supply per channel calculation step S14 in FIG. 2, from the result of the status assessment step S13, the maximum downlink power supply per channel is calculated by the following method and the result is passed to the setting correction step S15.

—Calculation Method—

   |(measured total power supply)−(estimated total power supply)|=Δp [W]
(correction value)=Δp/N
(setting value)=(power supply per channel required to maintain the minimum quality)+(correction value)
(power supply per channel required to maintain the minimum quality) is the un-corrected maximum value according to the embodiment of the present invention.

Following is an example of calculation when P′=16[W].

Case 1

traffic volume 40 terminals
measured total power supply 15W

From the calculation method above, (estimated total power supply)=16.6W
→pattern 1
Maximum downlink power supply per channel is not corrected.
   Case 2
   traffic volume 30 terminals
   measured total power supply 12.3W

From the calculation method above,
(estimated total power supply)=10.7W
(measured total power supply)<P′
(estimated total power supply)<P′
(measured total power supply)−(estimated total power supply)>0
→pattern 2
Terminals are considered to be gathering around the boundary (edge of coverage) of the area covered by the base station, and it is not desirable to alter (to increase) the maximum downlink power supply, thus the maximum downlink power supply per channel is not corrected.
   Case 3
   traffic volume 30 terminals
   measured total power supply 6.2W

From the calculation method above,
(estimated total power supply)=10.7W
(measured total power supply)<P′
(estimated total power supply)<P′
(measured total power supply)−(estimated total power supply)<0
→pattern 3

$$\begin{matrix}Δ p = \vert ( measured total power supply ) - \\ ( estimated total power supply ) \vert \\ = 4.5 [ W ] \\ ( correction value ) = Δ p / N \\ = 4.5 / 30 \\ = 0.15 [ W ] \\ ( setting value ) = ( power supply per channel required to maintain \\ the minimum quality ) + ( correction value ) \\ = 0.8 + 0.15 \\ = 0.95 [ W ]\end{matrix}$$

When assumed that
(power supply per channel required to maintain the minimum quality)=0.8 W

Usually, terminals that users possess evaluate the quality of the received signals and request the correction of power supply within the maximum downlink power supply per channel to the base station. The base station tries to maintain the speech quality of terminal that the user possesses by increasing and decreasing the power supply within the range of maximum downlink power supply. In the embodiments of the present invention, when a base station has remaining power in the actual total power supply, the base station can transmit signals with more power to terminals by increasing the maximum downlink power supply per channel on demand by terminals. This system enables base stations to provide communication service with better speech quality when the number of terminal covered by the base station is small.

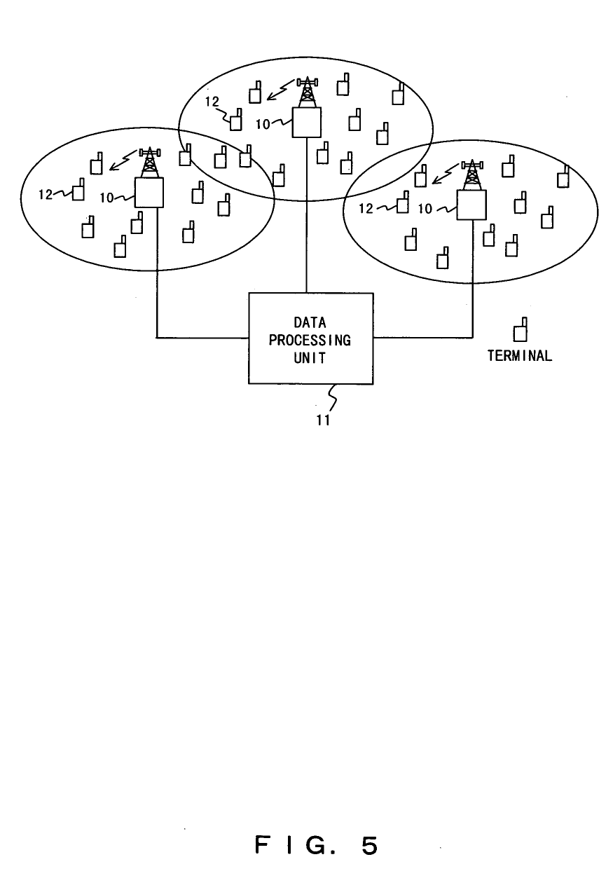

FIG. 5 is a block diagram describing a wireless communication system controlled in view of interference from neighboring base stations in the embodiment of the present invention.

In FIG. 5, a wireless communication system comprises a plurality of base stations 10 and a data processing unit 11 that collectively controls the base stations. Data collected in a plurality of base stations 10 is all processed in the data processing unit 11. To terminals 12, radio waves are transmitted from the base station 10 within the maximum downlink power supply per channel, which the data processing unit 11 set for each base station 10.

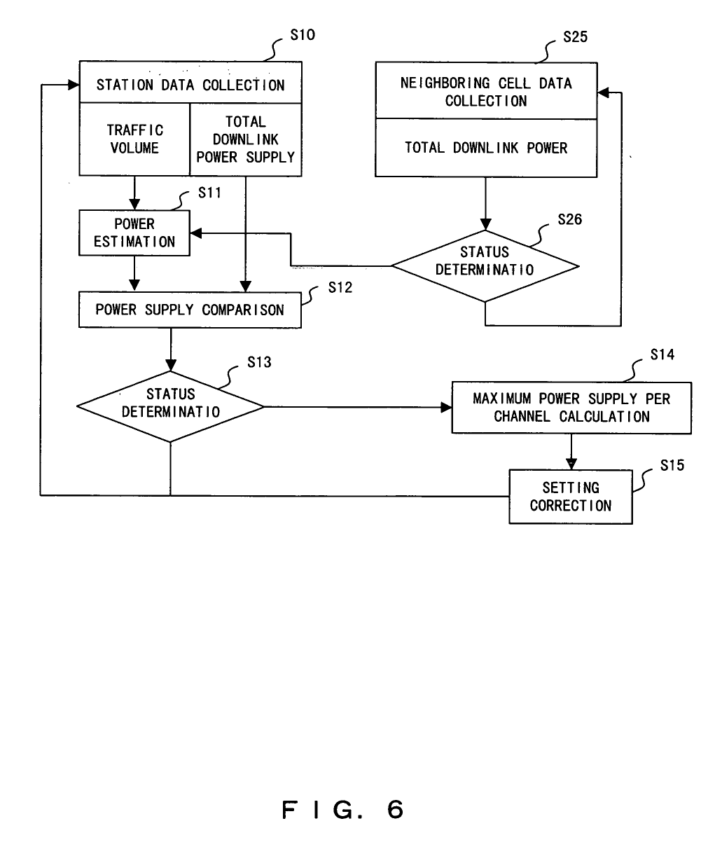

FIG. 6 is a flowchart showing processing to control the maximum downlink power supply per channel at a base station in view of interference from neighboring base stations.

The explanation of data collection step S10 through status assessment step S13 is omitted as the processing is the same as that of FIG. 2.

Neighboring cell data collection step S25 collects the data on the total power supply of neighboring cells. In the status determination step S26 the status of the neighboring base stations is determined, such as whether the maximum downlink power supply per channel should be in normal state or whether conditions should be added to the setting because influence on neighboring cells is predicted.

Assume that the data to identify which cells are adjacent to the cell is obtained from the step of the cell design in the system planning and is stored in data processing unit 11.

In the maximum power supply per channel calculation step S14, the maximum downlink power supply per channel is calculated when it is determined that a correction is required based on the result of the status determination step S13 from the condition resulted from the status determination step S26.

In the setting correction step S15, the result of the maximum power supply per channel calculation step S14 is applied to the base station. An example of such a calculation is given below.

Neighboring cell data collection step S25 of FIG. 6 collects the actual total power supply of cells adjacent to the base station cell in a certain cycle.

The collected data is sent to the status determination step S26.

The status determination step S26 conducts the following process and sends the outcome, value of f (the interference factor) to the power estimation step S11.

In the power estimation step S11, regarding the value of f (the interference factor), the result of the status determination step S26, values are substituted to the equation (1) which is processed as described in FIG. 2.

—Processing of Status Determination Step S26—

When neighboring base stations exist, a base station is influenced by the neighboring base stations. Thus, the base station has to increase the amount of power supplied regularly to the amount that the influence of interference is negated. In other words, if the base station increases its power supply, the base station causes an interference influence on the neighboring base stations. Therefore, the base station needs to be controlled considering the status of the neighboring base stations so as not to interfere with the neighboring base stations.

An example of such control is shown below. The number of cells adjacent to the cell of a base station is n.

In relation to the base station total power supply, P_limit: limit of total power supply in a base station P_low: 0.5*P_limit

P_low is the power supply lower limit, below which degradation of speech quality occurs. It is calculated as half the limit of the total power supply in a base station, based on the principle that performance degradation generally begins when a system is loaded to 50% of its maximum load.

Status determination step S26 perform processing as following and sends the outcome to the power estimation step S11.
Pattern 1: When all cell (n cells) meet the criteria (total power supply<P_low), f=0.2
Pattern 2: When more than ⅔*n cells and fewer than n cells meet the criteria (total power supply<P_low), f=0.4
Pattern 3: When more than ⅓*n cells and fewer than ⅔ cells meet the status (total power supply<P_low), f=0.6
Pattern 4: When more than 0 cell and fewer than ⅓ cells meet the status (total power supply<P_low), f=0.8 The value f, the outcome of status determination step S26, is sent to the power estimation step S11. The interference factor f is substituted to the equation (1), and the same processing is performed as described in FIG. 2.
   —Calculation Example—
1) Processing in status determination step S26
P limit=16 [W]
P_low=0.5*P limit=8 [W]

There are 6 neighboring cells and the power supply of each is P1, P2, P3, P4, P5, P6, [W], respectively. Table 4 shows four patterns of f value calculations based on the above assumptions.

TABLE 4
Processing of status determination B

| | | | | | | | Number of | | |
|---|---|---|---|---|---|---|---|---|---|
| | P1 | P2 | P3 | P4 | P5 | P6 | <P_low | Pattern | f |
| Case 1 | 5 | 5.5 | 6 | 6.5 | 7 | 7.5 | 6 | 1 | 0.2 |
| Case 2 | 5 | 5.5 | 6 | 6.5 | 13 | 14 | 4 | 2 | 0.4 |
| Case 3 | 5 | 5.5 | 11 | 12 | 13 | 14 | 2 | 3 | 0.6 |
| Case 4 | 9 | 10 | 11 | 12 | 13 | 14 | 0 | 4 | 0.8 |

2) Calculation of Maximum Downlink Power Supply per Channel Under Interference

The estimated total power supply of Case 4 in 1) processing in status determination step S26 is calculated. Power supply in each area with traffic volume of 30 terminals is shown in Table 5.

TABLE 5
Power supply in each area with traffic volume of 30
terminals (interfered: f = 0.8)

| | | | Total | | Traffic CH | | | |
|---|---|---|---|---|---|---|---|---|
| | Power | | power | | total | | | |
| | supply per | | supply in | | power | | | |
| Area | channel | | each area | | supply | | Poh added | |
| 1 | 67.8 | mW | 0.07 | W | 9.0 | W | 13.0 | W |
| 2 | 71.6 | | 0.10 | | | | | |
| 3 | 83.6 | | 0.20 | | | | | |
| 4 | 111.0 | | 0.37 | | | | | |
| 5 | 164.9 | | 0.34 | | | | | |
| 6 | 241.5 | | 1.17 | | | | | |
| 7 | 380.1 | | 2.38 | | | | | |
| 8 | 567.0 | | 3.88 | | | | | |

With the following conditions, the calculation of maximum downlink power supply per channel is given below.
—Conditions—
Traffic volume 30 terminals
Measured total power supply 12W
From the above-mentioned calculation method, estimated total power supply=13[W]
measured total power supply<P′
estimated total power supply<P′
measured total power supply−estimated total power
supply<0→pattern 3

$$\begin{matrix}Δ p = \vert ( measured total power supply ) - \\ ( estimated total power supply ) \vert \\ = 1 [ W ] \\ ( correction value ) = Δ p / N \\ = 1 / 30 \\ = 0.033 [ W ] \\ ( setting value ) = ( power supply per channel required to maintain \\ a minimum quality ) + ( correction value ) \\ = 0.8 + 0.033 \\ = 0.833 [ W ]\end{matrix}$$

When assumed that (power supply per channel required to maintain a minimum quality)=0.8W.

As described above, determination of remaining power to supply in a base station considering the an amount of interference by neighboring base stations allows more appropriate setting of the maximum downlink power supply per channel.

What is claimed is:

1. A wireless system, which performs wireless communication between base stations and terminals, comprising:
a station information collecting unit for collecting data of total power supply from the base station and the number of terminals covered by the base station as traffic volume,;
a total power supply estimation unit for estimating the total power supply required to the base station, from the traffic volume;
a status determining unit for determining whether the base station has remaining power or not using the actual total power supply and the estimated total power supply; and
a correction unit for correcting the setting of the maximum downlink power supply per channel that is provided to radio wave transmitted to terminals to a larger value when it is determined that the base station has some remaining power to supply by the status determining unit.

2. The wireless system according to claim 1, wherein the wireless system further comprising an interference amount estimation unit for estimating an amount of radio wave interference from the cells covered by neighboring base stations, and the total power supply estimation unit estimates the total power supply regarding the radio wave interference.

3. The wireless system according to claim 1, wherein the status determining unit determines that the base station has remaining power to supply when both the actual total power supply and the estimated total power supply are less than a predetermined value, and when the actual total power supply is less than the estimated total power supply.

4. The wireless system according to claim 1, wherein the correction unit obtains the post-correction setting value of the maximum downlink power supply per channel by adding the outcome of subtraction of the actual total power supply value from the estimated total power supply value, divided by the traffic volume to the pre-correction setting of maximum downlink power supply per channel.

5. The wireless system according to claim 2, wherein the interference amount estimation unit designates an interference factor, used for estimation of the total power supply, based on the number of base stations that have a total power supply of more than 50% of its limit total power supply among the neighboring base stations.

6. The wireless system according to claim 1, wherein the wireless communication is a system using CDMA technology.

7. The wireless system according to claim 1, wherein the wireless system is established in the base station.

8. The wireless system according to claim 1, wherein the wireless system is established in a facility other than the base station, and the wireless system obtains required data from the base station and makes setting in the base station through network.

9. The wireless system according to claim 2, wherein the wireless system controls a plurality of base stations.

10. The wireless system according to claim 1, wherein the total power supply is estimated under the assumption that the terminals are distributed uniformly within a cell covered by the base station.

11. A wireless control technique of a wireless communication system, which performs signal transmission by radio wave between base stations and terminals, comprising:
collecting data of total power supply from the base station and traffic volume, the number of terminals covered by the base station;
estimating the total power supply required to the base station, from the traffic volume;
determining the status whether the base station has remaining power to supply or not using the actual total power supply and the estimated total power supply; and
correcting the setting of the maximum downlink power supply per channel that is provided to radio wave transmitted to terminals to a larger value when it is determined that the base station has some remaining power to supply by the step of determining the status.

12. The wireless control technique according to claim 11, wherein the wireless control technique further comprising:
estimating the amount of radio wave interference from the cells covered by neighboring base stations, and the step of estimating the total power supply estimates the total power supply regarding the radio wave interference.
